(19) United States
(12) Patent Application Publication
(10) Pub. No.: US 2024/0279387 A1
(43) Pub. Date: Aug. 22, 2024

(54) LIQUID CRYSTAL POLYMER RESIN AND FORMED MATERIAL COMPRISING THE SAME

(71) Applicant: Chang Chun Plastics Co., Ltd., Taipei City (TW)

(72) Inventors: Chia-Hung WU, Taipei City (TW); Ching-Jui HUANG, Taipei City (TW); An-Pang TU, Taipei City (TW)

(21) Appl. No.: 18/210,802

(22) Filed: Jun. 16, 2023

(30) Foreign Application Priority Data
Feb. 15, 2023 (CN) 202310114906.5
Feb. 15, 2023 (TW) 112105437

(51) Int. Cl. C08G 63/06

(52) U.S. Cl. CPC C08G 63/065

(57) ABSTRACT

Provided are a liquid crystal polymer resin and a formed material comprising the same. The liquid crystal polymer resin comprises a structure unit represented by Formula (I). The thermal weight loss of the liquid crystal polymer resin is greater than 0.038% and less than 0.108%. The formed material made from the liquid crystal polymer resin has tensile strength of 1300 kgf/cm² or more, tensile modulus of 5000 MPa or more, and elongation at break of 8.0% or less. Besides, the formed material made from the recycled liquid crystal polymer resin contains similar mechanical properties as the formed material made from the one before recycling, which indicates that the recycled liquid crystal polymer resin has potential to product reprocessing and meet the requirement of green process.

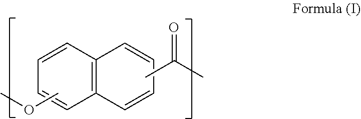

### CROSS-REFERENCE TO RELATED APPLICATION

Pursuant to 35 U.S.C. § 119(a), this application claims the benefit of the priority to Taiwan Patent Application No. 112105437 filed on Feb. 15, 2023, and the priority to China Patent Application No. 202310114906.5 filed on Feb. 15, 2023. The contents of the prior applications are incorporated herein by its entirety.

### BACKGROUND OF THE INVENTION

### 1. Field of the Invention

The present disclosure relates to a liquid crystal polymer resin (LCP resin) and a formed material comprising the same, particularly to an LCP resin and a formed material comprising the same with good mechanical properties.

### 2. Description of the Prior Arts

The LCP resin includes aromatic rings, aliphatic rings, and aliphatic chains in its structure and has molecular chains arranged in an orderly manner. Unlike traditional plastics, which are composed of scattered molecular chains and prone to residual internal stress during the molding process, LCP resin can maintain a stable form after cooling and solidification due to the directional molecular chain arrangement, so it becomes a preferred molding processing material.

The LCP film is now widely used in the fields of electronic appliances, the automobile industry, and aerospace, among which the circuit board components for electronic appliances use the LCP film the most. In recent years, the global demand for LCP resin has increased rapidly and has exceeded 70,000 tons. Since a product made with the LCP film and having high tensile strength, high tensile modulus, and low elongation at break is actively pursued, how to comprehensively improve the mechanical properties of LCP resins has become one of the subjects to be improved by those skilled in the art.

Therefore, there is still a need to improve the mechanical properties of LCP resins to meet the industry needs of various applied products.

### SUMMARY OF THE INVENTION

In view of the defects in the prior art, one of the objectives of the present disclosure is to provide an LCP resin with good mechanical properties.

To achieve the aforementioned objective, the present disclosure provides an LCP resin, comprising a structure unit represented by the following Formula (I), and a thermal weight loss of the LCP resin is greater than 0.038% and less than 0.108%:

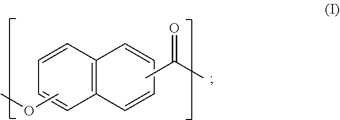

wherein the thermal weight loss of the LCP resin is obtained by the formula of [(W₁−W₂)/W₁]×100%, wherein W₁ represents a weight of the LCP resin at a constant temperature of 80° C. for one minute and W₂ represents a weight of the LCP resin at a constant temperature of melting point for one minute.

According to the present disclosure, a formed material made from the LCP resin, which has the structure unit of the Formula (I) and the thermal weight loss range, has good mechanical properties. Specifically, the LCP resin of the present disclosure can exhibit rigid properties, and the obtained formed material has high tensile strength and high tensile modulus.

In one of the embodiments, a melting point of the LCP resin may be 230° ° C. to 360° C. Preferably, the melting point of the LCP resin may be 260° C. to 330° C.

Preferably, a thermal weight loss of the LCP resin may be greater than or equal to 0.040% and less than or equal to 0.100%. In one of the embodiments, a thermal weight loss of the LCP resin may be greater than or equal to 0.050% and less than or equal to 0.088%. Optionally, a thermal weight loss of the LCP resin may be 0.050%, 0.051%, 0.052%, 0.053%, 0.054%, 0.055%, 0.056%, 0.057%, 0.058%, 0.059%, 0.060%, 0.061%, 0.062%, 0.063%, 0.064%, 0.065%, 0.066%, 0.067%, 0.068%, 0.069%, 0.070%, 0.071%, 0.072%, 0.073%, 0.074%, 0.075%, 0.076%, 0.077%, 0.078%, 0.079%, 0.080%, 0.081%, 0.082%, 0.083%, 0.084%, 0.085%, 0.086%, 0.087%, or 0.088%, but not limited thereto, and the above-mentioned specific values of the thermal weight loss of the LCP resin may be used as endpoints of other numerical ranges.

Preferably, a thermal degradation temperature (Td₉₉) at 1% thermal weight loss of the LCP resin may be greater than or equal to 270° C. More preferably, the thermal degradation temperature at 1% thermal weight loss of the LCP resin may be 280° ° C. to 400° C. Even more preferably, the thermal degradation temperature at 1% thermal weight loss of the LCP resin may be 290° ° C. to 390° C. Optionally, the thermal degradation temperature at 1% thermal weight loss of the LCP resin may be 290° C., 300° C., 310° ° C., 320° C., 330° C., 340° C., 350° C., 360° C., 370° C., 380° C., or 390° C., but not limited thereto, and the above-mentioned specific values of the thermal degradation temperature at 1% thermal weight loss of the LCP resin may be used as endpoints of other numerical ranges.

In one of the embodiments, the Formula (I) contained in the LCP resin may be:

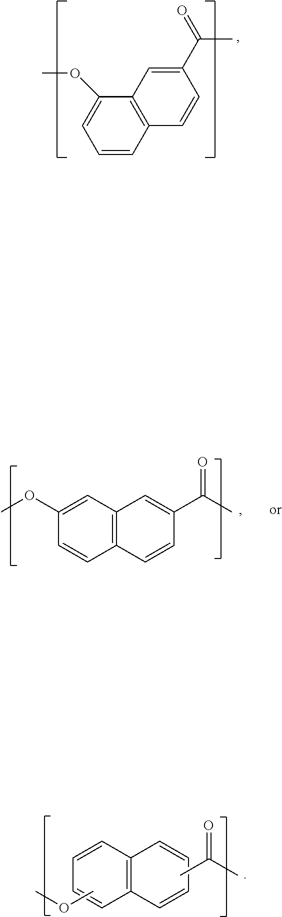

In one of the embodiments, in addition to the structure unit of Formula (I), the LCP resin further comprises a structure unit represented by the following Formula (II):

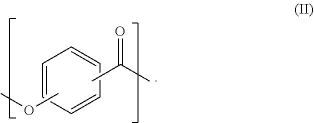

For example, the Formula (II) may be

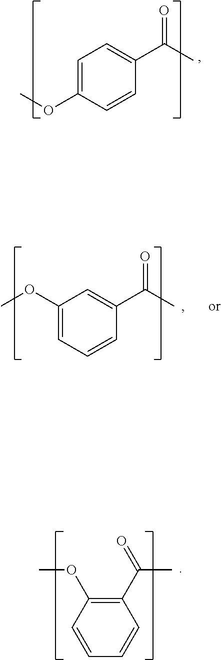

In one of the embodiments, the structure of the LCP resin has a naphthalene ring (such as the structure unit represented by Formula (I)). Preferably, the LCP resin of the present disclosure is a wholly aromatic polyester. In the aforementioned embodiment, a melt strength of the LCP resin may be 2.0 centinewtons (cN) or more. Preferably, the melt strength of the LCP resin may be 2.5 cN or more. More preferably, the melt strength of the LCP resin may be 3.0 cN or more.

According to the present disclosure, the LCP resin is an unrecycled LCP resin, a recycled LCP resin, or a combination thereof.

In one of the embodiments, when the LCP resin includes an unrecycled LCP resin, the “unrecycled LCP resin” refers to the LCP resin that has not been made into a formed material from an original LCP resin material and then recycled, and the original LCP resin material can undergo a heat treatment, but not limited thereto. A temperature of the heat treatment may be 120° C. to 220° C., and a time of the heat treatment may be 2 hours to 8 hours.

In addition, in one of the embodiments, when the LCP resin includes a recycled LCP resin, the “recycled LCP resin” refers to the LCP resin which is obtained by recycling the formed material made from LCP resin, and the recycling process can be adjusted according to demand. For example, the recycling process may include steps such as pulverization, heat treatment, melt mixing, thermal decomposition, chemical degradation, etc., but not limited thereto. If necessary, the formed material made from the recycled LCP resin can be recycled multiple times (for example, 2 times, 3 times, and 4 times) during the recycling process, and then the recycled LCP resin can be reused in the preparation of the formed material. The aforementioned steps may be repeated several times as required. In one of the embodiments, a temperature of the heat treatment may be 120° C. to 220° C., and a time of the heat treatment may be 2 hours to 8 hours during the recycling process.

In one of the embodiments, the LCP resin includes a combination of the unrecycled LCP resin and the recycled LCP resin. Under the condition that the technical effect of the present application is not negatively affected, the unrecycled LCP resin and the recycled LCP resin can be mixed at any proportion. In one of the embodiments, an amount of the recycled LCP resin is less than or equal to 40 weight percent (wt %) based on a total weight of the LCP resin, such as but not limited to, less than or equal to 30 wt %. In one of the embodiments, an amount of the recycled LCP resin is less than or equal to 25 wt % based on a total weight of the LCP resin, but not limited thereto.

According to the present disclosure, the LCP resin can be in the form of granular fine powder or strips. In one of the embodiments, the granular fine powder of the LCP resin has a particle size of 10 mm or less. More preferably, the granular fine powder of the LCP resin has a particle size of 0.005 mm to 10 mm. In another embodiment, the length of the long side of the LCP resin strip is 20 mm or less.

In one of the embodiments, the thermal weight loss of the liquid crystal polymer resin is analyzed by using a thermogravimetric analyzer, and the W₁ represents the weight of the liquid crystal polymer resin at the constant temperature of 80° C. for one minute under a nitrogen atmosphere with a flow rate of 60 milliliter per minute

The present disclosure further provides a formed material, which is made from the LCP resin. The formed material has a tensile strength of 1300 kgf/cm² or more, a tensile modulus of 5000 MPa or more, and an elongation at break of 8.0% or less.

According to the present disclosure, the formed material can be obtained by molding the LCP resin. For example, the molding process can be injection molding, extrusion molding, compression molding, blow molding, calendar molding, or tape casting, but not limited thereto. In an embodiment of the present disclosure, the formed material is obtained by injection molding the LCP resin.

According to the present disclosure, the formed material can be molded into various shapes as required, for example, the formed material may be in the shape of a strip or film, but not limited thereto.

In one of the embodiments, the tensile strength of the formed material may be 1310 kgf/cm² or more. Preferably, the tensile strength of the formed material may be 1320 kgf/cm² or more. In another embodiment, the tensile modulus of the formed material may be 5100 MPa or more. Preferably, the tensile modulus of the formed material may be 5200 MPa or more. More preferably, the tensile modulus of the formed material may be 5300 MPa or more. In further another embodiment, the elongation at break of the formed material may be 7.5% or less. Preferably, the elongation at break of the formed material may be 7.0% or less. More preferably, the elongation at break of the formed material may be 6.5% or less.

In another embodiment, the formed material has the tensile strength of kgf/cm² to 1500 kgf/cm², the tensile modulus of 5000 MPa to 7000 MPa, and the elongation at break of 3.0% to 8.0%.

In one of the embodiments, the formed material is made from recycled LCP resin, which has similar mechanical properties to the formed material made from LCP resin before recycling. Therefore, when the LCP resin of the present disclosure is a recycled LCP resin, it is suitable for reuse in various applications, which meets the requirements of green manufacturing processes.

In one of the embodiments, the formed material is made from recycled LCP resin. Compared with the formed material made from unrecycled LCP resin, the formed material made from recycled LCP resin has a tensile strength retention rate of more than 90% and a tensile modulus retention rate of more than 80%. Preferably, the formed material made from recycled LCP resin has a tensile strength retention rate of more than 95% and a tensile modulus retention rate of more than 85%. More preferably, the formed material made from recycled LCP resin has a tensile strength retention rate of more than 95% and a tensile modulus retention rate of more than 88%.

In another embodiment, the formed material may be made from LCP resin recycled-multiple-times. Compared with the formed material made from unrecycled LCP resin, the formed material made from recycled-multiple-times LCP resin has the tensile strength retention rate of more than 90% and the tensile modulus retention rate of more than 80%. Preferably, the formed material made from recycled-multiple-times LCP resin has the tensile strength retention rate of more than 95% and the tensile modulus retention rate of more than 85%. More preferably, the formed material made from recycled-multiple-times LCP resin has the tensile strength retention rate of more than 95% and the tensile modulus retention rate of more than 88%.

### DETAILED DESCRIPTION OF THE PREFERRED EMBODIMENTS

Hereinafter, several preparation examples and examples are described to illustrate the embodiments of a liquid crystal polymer resin and formed material comprising the same, and several comparative examples are provided for comparison. One person having ordinary skills in the art can easily realize the advantages and effects of the present invention from the following examples and comparative examples. It should be understood that the descriptions proposed herein are just preferable examples for the purpose of illustrations only, not intended to limit the scope of the present disclosure. One person having ordinary skills in the art can make various modifications and variations to practice or apply the present disclosure in accordance with the ordinary knowledge without departing from the spirit and scope of the present disclosure.

[symbol]

Original LCP Resin Particles

[symbol]

### Preparation Example 1

A mixture of 6-hydroxy-2-naphthalene carboxylic acid (540 g), 4-hydroxybenzoic acid (1071 g), acetic anhydride (1085 g), and sodium phosphite (1.3 g) was charged into a 3-liter autoclave and stirred for acetylation at 160° C. for about 2 hours under a nitrogen atmosphere at normal pressure. Subsequently, the mixture was heated to 320° C. at a heating rate of 30° C. per hour. Under this temperature condition, the pressure was slowly reduced from 760 torr to 3 torr or below, and the temperature was increased from 320° C. to 340° C. Afterwards, the stirring power and pressure were increased, and steps of discharging polymers, drawing strands, and cutting strands into pellets were conducted to obtain an original LCP resin material of Preparation Example 1, which had a melting point of about 280° C. and a viscosity of about 40 Pa·s @300° C.

The original LCP resin material was placed into a twin-screw extruder with a screw diameter of 27 millimeters (mm) (manufacturer: Leistritz, model: ZSE27) and was heated to a temperature ranging from 260° C. to 340° ° C. for melting. The melted original LCP resin material was then extruded into strips through a die with a diameter of 2 mm, cooled in the air, and finally pelletized with a pelletizer (manufacturer: Reduction Engineering Scheer, model: B64) to obtain original LCP resin particles of Preparation Example 1.

### Preparation Example 2

A mixture of 6-hydroxy-2-naphthalene carboxylic acid (400 g), 4-hydroxybenzoic acid (1175 g), acetic anhydride (1085 g), and sodium phosphite (1.3 g) was charged into a 3-liter autoclave and stirred for acetylation at 160° C. for about 2 hours under a nitrogen atmosphere at normal pressure. Subsequently, the mixture was heated to 320° ° C. at a heating rate of 30° C. per hour. Under this temperature condition, the pressure was slowly reduced from 760 torr to 3 torr or below, and the temperature was increased from 320° C. to 340° ° C. Afterwards, the stirring power and pressure were increased, and steps of discharging polymers, drawing strands, and cutting strands into pellets were conducted to obtain an original LCP resin material of Preparation Example 2, which had a melting point of about 320° C. and a viscosity of about 40 Pas @320° C.

The original LCP resin material was placed into a twin-screw extruder with a screw diameter of 27 millimeters (mm) (manufacturer: Leistritz, model: ZSE27) and was heated to a temperature ranging from 260° C. to 340° ° C. for melting. The melted original LCP resin material was then extruded into strips through a die with a diameter of 2 mm, cooled in the air, and finally pelletized with a pelletizer (manufacturer: Reduction Engineering Scheer, model: B64) to obtain original LCP resin particles of Preparation Example 2.

### Preparation Example 3

A mixture of terephthalic acid (266 g), isophthalic acid (150 g), 4-hydroxybenzoic acid (690 g), diphenol (466 g), and acetic anhydride (1123 g) was charged into a 3-liter autoclave and stirred for acetylation at 160° C. for about hours under a nitrogen atmosphere at normal pressure. Subsequently, the mixture was heated to 340° ° C. at a heating rate of 30° C. per hour. Under this temperature condition, the pressure was slowly reduced from 760 torr to 3 torr or below, and the temperature was increased from 340° ° C. to 360° ° C. Afterwards, the stirring power and pressure were increased, and steps of discharging polymers, drawing strands, and cutting strands into pellets were conducted to obtain an original LCP resin material of Preparation Example 3, which had a melting point of about 310° C. and a viscosity of about 20 Pas @340° C.

The original LCP resin material was placed into a twin-screw extruder with a screw diameter of 27 millimeters (mm) (manufacturer: Leistritz, model: ZSE27) and was heated to a temperature ranging from 260° C. to 340° C. for melting. The melted original LCP resin material was then extruded into strips through a die with a diameter of 2 mm, cooled in the air, and finally pelletized with a pelletizer (manufacturer: Reduction Engineering Scheer, model: B64) to obtain original LCP resin particles of Preparation Example 3.

[symbol]

Recycled LCP Resin Particles

[symbol]

### Example 1

The original LCP resin particles in Preparation Example 1 were used as raw materials, dried at 140° ° C. overnight (i.e., at least 4 hours of drying), and then, using an injection molding machine (model: YC90, manufacturer: Year-Chance Machinery Co.) for specimen molding. Molding conditions include a melting temperature of 270° C. to 340° C., a mold temperature of 80° ° C. to 120° C., and an injection back pressure of 5 bar to 15 bar. The dimensions of the mold specimen are conformed to the Type I dimensions specified in ASTM D638.

The specimen was ground by a crushing machine (model: A750, manufacturer: Pulian International Enterprise Co., Ltd.) to obtain a crushed material with a particle size of less than 10 mm. After that, the crushed material was placed in an oven (model: QHMO-7S, manufacturer: C Sun Mfg. Ltd.) for heat treatment to obtain a recycled LCP resin material. The heat treatment was performed at 140° ° C. for 3 hours.

The recycled LCP resin material was put into a twin-screw extruder having a screw diameter of 27 mm (model: ZSE27; manufacturer: Leistritz) and heated to a temperature ranging from 260° C. to 340° ° C. The melted recycled LCP resin material was extruded into strips through a die with a diameter of 2 mm, cooled in the air, and then pelletized by a pelletizer (model: B64; manufacturer: Reduction Engineering Scheer) to obtain the recycled LCP resin particles of Example 1. It can be understood that the recycled LCP resin particles of Example were the recycled LCP resin particles, which were substantially recycled once.

### Examples 2 to 8

The recycled LCP resin particles of Examples 2 to 8 were prepared by roughly the same manufacturing process as Example 1. The main difference between Examples 2 to 8 and Example 1 lies in the selected raw materials (original LCP resin particles), heat treatment temperature, and heat treatment time. The parameters are shown in Table 1 below. It can be understood that the recycled LCP resin particles in Examples 2 to 8 were the recycled LCP resin particles, which were substantially recycled once.

### Example 9

In Example 9, the recycled LCP resin particles in Example 2 were used as raw materials to make specimen and then were recycled again. The specific process is described as follows.

The recycled LCP resin particles of Example 2 were used as raw materials, dried at 140° ° C. overnight (i.e., at least 4 hours of drying), and then, using an injection molding machine (model: YC90, manufacturer: Year-Chance Machinery Co.) for specimen molding. Molding conditions include a melting temperature of 270° ° C. to 340° C., a mold temperature of 80° ° C. to 120° C., and an injection back pressure of 5 bar to 15 bar. The dimensions of the mold specimen are conformed to the Type I dimensions specified in ASTM D638.

The specimen was ground by a crushing machine (model: A750, manufacturer: Pulian International Enterprise Co., Ltd.), to obtain a crushed material with a particle size of less than 10 mm. After that, the crushed material was placed in an oven (model: QHMO-7S, manufacturer: C Sun Mfg. Ltd.) for heat treatment to obtain a recycled LCP resin material. The heat treatment was performed at 140° ° C. for 6 hours.

The recycled LCP resin material was put into a twin-screw extruder having a screw diameter of 27 mm (model: ZSE27; manufacturer: Leistritz) and heated to a temperature ranging from 260° C. to 340° ° C. The melted recycled LCP resin material was extruded into strips through a die with a diameter of 2 mm, cooled in the air, and then pelletized by a pelletizer (model: B64; manufacturer: Reduction Engineering Scheer) to obtain the recycled LCP resin particles of Example 9. It can be understood that the recycled LCP resin particles of Example were recycled LCP resin particles, which were substantially recycled twice.

### Example 10

In Example 10, the recycled LCP resin particles in Example 9 were used as raw materials to make specimen and then were recycled again. The specific process is described as follows.

The recycled LCP resin particles of Example 9 were used as raw materials, dried at 140° ° C. overnight (i.e., at least 4 hours of drying), and then, using an injection molding machine (model: YC90, manufacturer: Year-Chance Machinery Co.) for specimen molding. Molding conditions include a melting temperature of 270° ° C. to 340° C., a mold temperature of 80° ° C. to 120° C., and an injection back pressure of 5 bar to 15 bar. The dimensions of the mold specimen are conformed to the Type I dimensions specified in ASTM D638.

The specimen was ground by a crushing machine (model: A750, manufacturer: Pulian International Enterprise Co., Ltd.), to obtain a crushed material with a particle size of less than 10 mm. After that, the crushed material was placed in an oven (model: QHMO-7S, manufacturer: C Sun Mfg. Ltd.) for heat treatment to obtain a recycled LCP resin material. The heat treatment was performed at 140° ° C. for 6 hours.

The recycled LCP resin material was put into a twin-screw extruder having a screw diameter of 27 mm (model: ZSE27; manufacturer: Leistritz) and heated to a temperature ranging from 260° C. to 340° ° C. The melted recycled LCP resin material was extruded into strips through a die with a diameter of 2 mm, cooled in the air, and then pelletized by a pelletizer (model: B64; manufacturer: Reduction Engineering Scheer) to obtain the recycled LCP resin particles of Example 10. It can be understood that the recycled LCP resin particles of Example 10 were recycled LCP resin particles, which were substantially recycled three times.

### Example 11

In Example 11, the recycled LCP resin particles in Example 10 were used as raw materials to make specimen and then were recycled again. The specific process is described as follows.

The recycled LCP resin particles in Example 10 were used as raw materials, dried at 140° ° C. overnight (i.e., at least 4 hours of drying), and then, using an injection molding machine (model: YC90, manufacturer: Year-Chance Machinery Co.) for specimen molding. Molding conditions include a melting temperature of 270° ° C. to 340° C., a mold temperature of 80° C. to 120° C., and an injection back pressure of 5 bar to 15 bar. The dimensions of the mold specimen are conformed to the Type I dimensions specified in ASTM D638.

The specimen was ground by a crushing machine (model: A750, manufacturer: Pulian International Enterprise Co., Ltd.), to obtain a crushed material with a particle size of less than 10 mm. After that, the crushed material was placed in an oven (model: QHMO-7S, manufacturer: C Sun Mfg. Ltd.) for heat treatment to obtain a recycled LCP resin material. The heat treatment was performed at 140° ° C. for 6 hours.

The recycled LCP resin material was put into a twin-screw extruder having a screw diameter of 27 mm (model: ZSE27; manufacturer: Leistritz) and heated to a temperature ranging from 260° C. to 340° ° C. The melted recycled LCP resin material was extruded into strips through a die with a diameter of 2 mm, cooled in the air, and then pelletized by a pelletizer (model: B64; manufacturer: Reduction Engineering Scheer) to obtain the recycled LCP resin particles of Example 11. It can be understood that the recycled LCP resin particles of Example 11 were recycled LCP resin particles, which were substantially recycled four times.

### Example 12

In Example 12, the recycled LCP resin particles in Example 11 were used as raw materials to make specimen and then were recycled again. The specific process is described as follows.

The recycled LCP resin particles in Example 11 were used as raw materials, dried at 140° ° C. overnight (i.e., at least 4 hours of drying), and then, using an injection molding machine (model: YC90, manufacturer: Year-Chance Machinery Co.) for specimen molding. Molding conditions include a melting temperature of 270° ° C. to 340° C., a mold temperature of 80° C. to 120° C., and an injection back pressure of 5 bar to 15 bar. The dimensions of the mold specimen are conformed to the Type I dimensions specified in ASTM D638.

The specimen was ground by a crushing machine (model: A750, manufacturer: Pulian International Enterprise Co., Ltd.), to obtain a crushed material with a particle size of less than 10 mm. After that, the crushed material was placed in an oven (model: QHMO-7S, manufacturer: C Sun Mfg. Ltd.) for heat treatment to obtain a recycled LCP resin material. The heat treatment was performed at 140° ° C. for 6 hours.

The recycled LCP resin material was put into a twin-screw extruder having a screw diameter of 27 millimeters (mm) (model: ZSE27; manufacturer: Leistritz) and heated to a temperature ranging from 260° ° C. to 340° ° C. The melted recycled LCP resin material was extruded into strips through a die with a diameter of 2 mm, cooled in the air, and then pelletized by a pelletizer (model: B64; manufacturer: Reduction Engineering Scheer) to obtain the recycled LCP resin particles of Example 12. It can be understood that the recycled LCP resin particles of Example 12 were recycled LCP resin particles, which were substantially recycled five times.

### Comparative Examples 1 to 7

The recycled LCP resin particles of Comparative Examples 1 to 7 were prepared roughly the same as the manufacturing process of Examples 1 to 8. The main difference between Comparative Examples 1 to 7 and Examples 1 to 8 lies in the selected raw materials (original LCP resin particles), heat treatment temperature, and heat treatment time. The parameters are shown in Table 1 below. It can be understood that the recycled LCP resin particles in Comparative Examples 1 to 7 were recycled LCP resin particles, which were substantially recycled once.

[symbol]

Unrecycled LCP Resin Particles

[symbol]

### Examples 13 to 14

The difference between the unrecycled LCP resin particles of Examples 13 to 14 and the recycled LCP resin particles of Examples 1 to 12 is that Examples 13 to 14 were not first formed into specimens before being subjected to grinding treatment. Instead, Examples 13 to 14 used the original LCP resin material (not extruded and granulated) in the previous Preparation Examples as raw materials to directly perform heat treatment and granulation steps to obtain unrecycled LCP resin particles. The detailed steps are described as follows.

### Example 13

The original LCP resin material of Preparation Example 1 was dried at 140° C. overnight (i.e., at least 4 hours of drying), then placed in an oven (model: QHMO-7S, manufacturer: C Sun Mfg. Ltd.) for heat treatment to obtain an unrecycled LCP resin material, wherein the heat treatment was performed at 160° ° C. for 3 hours.

The unrecycled LCP resin material was put into a twin-screw extruder having a screw diameter of 27 mm (model: ZSE27; manufacturer: Leistritz) and heated to a temperature ranging from 260° C. to 340° ° C. The melted unrecycled LCP resin material was extruded into strips through a die with a diameter of 2 mm, cooled in the air, and then pelletized by a pelletizer (model: B64; manufacturer: Reduction Engineering Scheer) to obtain the unrecycled LCP resin particles of Example 13.

### Example 14

The original LCP resin material of Preparation Example 2 was dried at 140° ° C. overnight (i.e., at least 4 hours of drying), then placed in an oven (model: QHMO-7S, manufacturer: C Sun Mfg. Ltd.) for heat treatment to obtain an unrecycled LCP resin material, wherein the heat treatment was performed at 180° ° C. for 3 hours.

The unrecycled LCP resin material was put into a twin-screw extruder having a screw diameter of 27 mm (model: ZSE27; manufacturer: Leistritz) and heated to a temperature ranging from 260° C. to 340° ° C. The melted unrecycled LCP resin material was extruded into strips through a die with a diameter of 2 mm, cooled in the air, and then pelletized by a pelletizer (model: B64; manufacturer: Reduction Engineering Scheer) to obtain the unrecycled LCP resin particles of Example 14.

TABLE 1
raw material Nos., heat treatment temperatures, and heat treatment
times (N/A: not subjected to heat treatment) for the recycled
LCP resin particles of Examples 1 to 12 (E1 to E12) and Comparative
Examples 1 to 7 (C1 to C7), as well as the unrecycled LCP resin
particles of Examples 13 to 14 (E13 to E14).

| | | Temperature of | Time of heat |
|---|---|---|---|
| Sample | | heat treatment | treatment |
| No. | Raw material No. | (° C.) | (hour) |
| E1 | Preparation Example 1 | 140 | 3 |
| E2 | Preparation Example 1 | 140 | 6 |
| E3 | Preparation Example 1 | 200 | 3 |
| E4 | Preparation Example 1 | 200 | 6 |
| E5 | Preparation Example 2 | 140 | 3 |
| E6 | Preparation Example 2 | 140 | 6 |
| E7 | Preparation Example 2 | 200 | 3 |
| E8 | Preparation Example 2 | 200 | 6 |
| E9 | Example 2 | 140 | 6 |
| E10 | Example 9 | 140 | 6 |
| E11 | Example 10 | 140 | 6 |
| E12 | Example 11 | 140 | 6 |
| E13 | Preparation Example 1 | 160 | 3 |
| E14 | Preparation Example 2 | 180 | 3 |
| C1 | Preparation Example 1 | N/A | N/A |
| C2 | Preparation Example 2 | N/A | N/A |
| C3 | Preparation Example 1 | 260 | 6 |
| C4 | Preparation Example 2 | 280 | 6 |
| C5 | Preparation Example 1 | 100 | 3 |
| C6 | Preparation Example 1 | 280 | 3 |
| C7 | Preparation Example 3 | 140 | 6 |

### Test Example 1: Thermal Weight Loss and Thermal Degradation Temperature

In Test Example 1, the recycled LCP resin particles of Examples 1 to 12 and Comparative Examples 1 to 7, as well as the unrecycled LCP resin particles of Examples 13 to 14 were used as test samples. A thermogravimetric analyzer (manufacturer: TA instruments, model: Q500) was used to conduct the test.

The test sample (W₀ grams) was taken and placed in a thermogravimetric analyzer, then heated to 80° C. and held constant for one minute under a nitrogen atmosphere (nitrogen flow rate: 60 ml/min). After that, the weight of the test sample was measured as W₁ grams. The test sample was then heated to the melting point of the test sample and held constant for one minute, and then the test sample was weighed and recorded as W₂ grams. The thermal weight loss of each test sample was calculated using the formula [(W₁−W₂)/W₁]×100%.

Next, a thermogravimetric curve was obtained by continuously heating the test sample, and the thermal degradation temperature of each test sample was obtained. The thermal degradation temperature corresponds to the temperature at which the thermal weight loss reaches 1.0%. The results are shown in Tables 2 to 4.

### Test Example 2: Mechanical Properties

The recycled LCP resin particles of Examples 1 to 12 and Comparative Examples 1 to 7, as well as the unrecycled LCP resin particles of Examples 13 to 14 were dried at 140° C. overnight. Then an injection molding machine (model: YC90, manufacturer: Year-Chance Machinery Co.) was used for specimen molding to obtain specimens of Examples 1A to 14A and Comparative Examples 1A to 7A. The molding conditions included a melt temperature of 270° C. to 340° C., mold temperature of 80° C. to 120° C., and injection back pressure of 5 bar to 15 bar. The dimensions of the mold specimens are conformed to the Type I dimensions specified in ASTM D638.

The specimens of Examples 1A to 14A and Comparative Examples 1A to 7A as test samples was to be analyzed. The test samples were analyzed using a universal testing machine (model: 3367, manufacturer: Instron) according to ASTM D638 to obtain the tensile strength, tensile modulus, and elongation at break of each sample. The testing temperature was 25° C., and the testing speed was 10 millimeters/minute. The results are shown in Table 2.

TABLE 2
the thermal weight loss and thermal degradation temperature
of Examples 1 to 14 (E1 to E14) and Comparative Examples
1 to 7 (C1 to C7); the tensile strength, tensile modulus,
and elongation at break of Examples 1A to 14A (E1A to E14A)
and Comparative Examples 1A to 7A (C1A to C7A).

| | Thermal | Thermal | | | |
|---|---|---|---|---|---|
| | weight | degradation | Tensile | Tensile | Elongation |
| | loss | temperature | strength | modulus | at break |
| | (%) | (° C.) | (kgf/cm²) | (Mpa) | (%) |
| E1/E1A | 0.088 | 298 | 1382.0 | 5931.2 | 4.3 |
| E2/E2A | 0.078 | 313 | 1372.1 | 5714.1 | 4.3 |
| E3/E3A | 0.071 | 315 | 1396.0 | 5415.4 | 4.6 |
| E4/E4A | 0.057 | 336 | 1369.9 | 5386.2 | 6.2 |
| E5/E5A | 0.082 | 342 | 1322.1 | 6614.1 | 3.7 |
| E6/E6A | 0.074 | 358 | 1358.4 | 6532.8 | 4.2 |
| E7/E7A | 0.058 | 374 | 1333.0 | 5992.8 | 4.4 |
| E8/E8A | 0.050 | 386 | 1332.8 | 5879.6 | 5.6 |
| E9/E9A | 0.070 | 314 | 1419.9 | 5586.2 | 4.2 |
| E10/E10A | 0.070 | 312 | 1398.6 | 5715.4 | 3.8 |
| E11/E11A | 0.080 | 311 | 1434.6 | 5731.2 | 4.3 |
| E12/E12A | 0.070 | 309 | 1413.0 | 5792.8 | 4.4 |
| E13/E13A | 0.083 | 318 | 1437.5 | 5815.6 | 4.5 |
| E14/E14A | 0.076 | 348 | 1362.9 | 6672.8 | 4.2 |
| C1/C1A | 0.113 | 268 | 1272.9 | 5717.2 | 3.8 |
| C2/C2A | 0.110 | 302 | 1216.8 | 6683.4 | 3.9 |
| C3/C3A | 0.036 | 366 | 1378.3 | 4382.9 | 11.3 |
| C4/C4A | 0.038 | 395 | 1386.3 | 4468.2 | 12.1 |
| C5/C5A | 0.108 | 278 | 1292.1 | 5752.8 | 4.4 |
| C6/C6A | 0.032 | 376 | 1386.0 | 4542.9 | 11.6 |
| C7/C7A | 0.090 | 276 | 1240.3 | 5010.3 | 3.7 |

As shown in Table 2, regardless of whether the recycled LCP resin particles from Examples 1 to 12 or the unrecycled LCP resin particles from Examples 13 and 14 were employed, the thermal weight loss of Examples 1 to 14 was greater than 0.038% and less than 0.108%. Furthermore, it is known from the selected raw materials that the structure units of Examples 1 to 14 all had a structure of naphthalene ring. In contrast, although Comparative Examples 1 to had a structure of naphthalene ring, their thermal weight loss was less than 0.038% or greater than or equal to 0.108%. Although the recycled LCP resin particles of Comparative Example 7 had a specific thermal weight loss, its structure unit did not have a naphthalene ring.

Therefore, compared to Comparative Examples 1 to 7, the prepared specimens of Examples 1 to 14 had higher tensile strength (for example, 1300 kgf/cm² or more), higher tensile modulus (for example, 5000 MPa or more), and lower elongation at break (for example, 8.0% or less). It can be seen that the LCP of the present disclosure has excellent rigidity properties, and the tensile strength, tensile modulus, and elongation at break of the formed material meet the industry's requirements.

In addition, to evaluate the tensile strength retention rate and tensile modulus retention rate of the specimens made from the recycled LCP resin particles, the tensile strength and tensile modulus of the specimens made from the unrecycled LCP resin particles of Examples 13 and 14 were used as the comparative benchmarks for the tensile strength retention rate and tensile modulus retention rate of the specimens made from the recycled LCP resin particles of Examples 1 to 12 and Comparative Examples 1 to 6. Furthermore, since Examples 1 to 4, 9 to 13 and Comparative Examples 1, 3, 5, and 6 all used Preparation Example 1 as the raw material, the tensile strength retention rate of Examples 1 to 4, 9 to 12, and Comparative Examples 1, 3, 5, and 6 were calculated by the following formula: [(tensile strength of specimens made from the recycled LCP resin particles)/(tensile strength of specimen made from the unrecycled LCP resin particles of Example 13)]*100%. Similarly, the tensile modulus retention rate was obtained according to the aforementioned formula. For example, the specimen of Example 13A was used as the comparative benchmark for the specimen of Example 1A, and the tensile strength retention rate and tensile modulus retention rate were obtained according to the aforementioned formula. The results are shown in Table 3 and Table 4. Besides, since the tensile strength retention rate of Examples 5 to 8 and 14 as well as Comparative Examples 2 and 4 all used Preparation Example 2 as raw material, the tensile strength retention rate of Examples 5 to 8 and Comparative Examples 2 and 4 were calculated by the following formula: [(tensile strength of specimens made from recycled LCP resin particles)/(tensile strength of specimen made from unrecycled LCP resin particles of Example 14)]*100%. Similarly, the tensile modulus retention rate was obtained according to the aforementioned formula. For example, the specimen of Example 14A was used as the comparative benchmark for the specimen of Example 5A, and the tensile strength retention rate and tensile modulus retention rate were obtained according to the aforementioned formula. The results are shown in Table 3 and Table 4.

TABLE 3
the thermal weight loss of Examples 1 to 8 (E1 to E8) and Comparative
Examples 1 to 6 (C1 to C6); the tensile strength retention rate
and tensile modulus retention rate of Examples 1A to 8A (E1A
to E8A) and Comparative Examples 1A to 6A (C1A to C6A).

| | Thermal weight | Tensile strength | Tensile modulus |
|---|---|---|---|
| | loss (%) | retention rate (%) | retention rate (%) |
| E1/E1A | 0.088 | 96.1 | 102.0 |
| E2/E2A | 0.078 | 95.5 | 98.3 |
| E3/E3A | 0.071 | 97.1 | 93.1 |
| E4/E4A | 0.057 | 95.3 | 92.6 |
| E5/E5A | 0.082 | 97.0 | 99.1 |
| E6/E6A | 0.074 | 99.7 | 97.9 |
| E7/E7A | 0.058 | 97.8 | 89.8 |
| E8/E8A | 0.050 | 97.8 | 88.1 |
| C1/C1A | 0.113 | 88.5 | 98.3 |
| C2/C2A | 0.110 | 89.3 | 100.2 |
| C3/C3A | 0.036 | 95.9 | 75.4 |
| C4/C4A | 0.038 | 101.7 | 67.0 |
| C5/C5A | 0.108 | 89.9 | 98.9 |
| C6/C6A | 0.032 | 96.4 | 78.1 |

As shown in Table 3 above, compared to Comparative Examples 1 to 6, the specimens made from recycled LCP resin particles in Examples 1 to 8, exhibited relatively high tensile strength retention rates and tensile modulus retention rates, which were conducive to remanufacturing into applied products.

On the contrary, the specimens made from recycled LCP resin particles of Comparative Examples 1 to 6 could not maintain the tensile strength and tensile modulus similar to the specimens made from unrecycled LCP resin particles, so it could not simultaneously keep high tensile strength retention rate and tensile modulus retention rate. The above results showed that the mechanical properties of these recycled LCP resin particles have been weakened after made into specimens, which could not meet the standards expected by the industry, and the LCP resin particles could not be effectively recycled and reused.

Furthermore, the following table 4 shows the tensile strength retention rate and the tensile modulus retention rate of recycled-multiple-times LCP resin particles, which were obtained by repeated recycling process of the recycled LCP resin particles (i.e. Example 2) as the raw material.

TABLE 4
the thermal weight loss of Examples 2, 9 to 12 (E2,
E9 to E12) and the recycling times, tensile strength
retention rate, and tensile modulus retention rate
of Examples 2A, 9A to 12A (E2A, E9A to E12A).

| | | | Tensile | Tensile |
|---|---|---|---|---|
| | | Thermal | strength | modulus |
| | Recycling | weight | retention | retention |
| | times | loss (%) | rate (%) | rate (%) |
| E2/E2A | 1 | 0.078% | 95.5 | 98.3 |
| E9/E9A | 2 | 0.070% | 98.8 | 96.1 |
| E10/E10A | 3 | 0.070% | 97.3 | 98.3 |
| E11/E11A | 4 | 0.080% | 99.8 | 98.5 |
| E12/E12A | 5 | 0.070% | 98.3 | 99.6 |

As shown in Table 4 above, the recycled LCP resin particles of Examples 2, 9 to 12 are the LCP resin particles recycled 1 to 5 times in sequence, and the tensile strength retention rate and tensile modulus retention rate are both 95% or more. It can be seen that by controlling the structure unit and the thermal weight loss, the LCP resin of the present disclosure can still have good mechanical properties after repeated recycling processes and is suitable for multiple recycling.

### Test Example 3: Melt Strength

In Test Example 3, the recycled LCP resin particles of Examples 2, 6 and Comparative Example 7 were used as test samples. A high pressure capillary rheometer (manufacturer: GOTTFERT, model: RHEOGRAPH 20) and a melt tension measurement instrument (manufacturer: GOTTFERT, model: RHEOTENS 71.97) were used to conduct the test.

The test sample was heated to 10° ° C. above its melting point to become a melt. When the melt flowed out through the capillary, it was introduced into a set of adjustable speed rollers before the melt was solidified (initial speed of the roller: 30 mm/s). The set of the rollers was connected to a set of micro analytical balances. The force required for stretching when the melt was broken was measured through the change in the speed of the aforementioned rollers. The melt strength obtained in Example 2 was 3.2 cN, the melt strength in Example 6 was 3.0 cN and the melt strength in Comparative Example 7 was 0.33 cN.

It can be known that the melt strengths of the recycled LCP resin of Examples 2 and 6 were significantly higher than that of the recycled LCP resin of Comparative Example 7. Further, the recycled LCP resin particles of Examples 2, 6 and Comparative Example 7 were made from the original LCP resin particles of Preparation Examples 1 to 3 respectively, wherein, the recycled LCP resin particles of Examples 2 and 6 all had a structure of naphthalene ring, while the recycled LCP resin particles of Comparative Example 7 did not have a structure of naphthalene ring. Therefore, Examples 2 and 6 had a structure of naphthalene ring and a specific range of thermal weight loss to have high melt strength after recycling, which is beneficial to subsequent processing and is not easy to break the film during the film making process.

In summary, the LCP resin of the present disclosure has a structure of naphthalene ring and a specific range of thermal weight loss, which can make the formed material made from the LCP resin have the characteristics of high tensile strength, high tensile modulus and low elongation at break. In one of the embodiments, the LCP resin of the present disclosure is recycled LCP resin, and the formed material obtained from it retains the similar mechanical properties of the formed material made from the LCP resin before recycling, which shows that it has the potential to be remanufactured into products and can meet the green manufacturing process.

What is claimed is:

1. A liquid crystal polymer resin, comprising a structure unit represented by the following Formula (I), and a thermal weight loss of the liquid crystal polymer resin being greater than 0.038% and less than 0.108%: 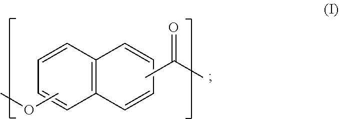
wherein the thermal weight loss of the liquid crystal polymer resin is obtained by the formula of [(W₁−W₂)/W₁]×100%, wherein W₁ represents a weight of the liquid crystal polymer resin at a constant temperature of 80° ° C. for one minute and W₂ represents a weight of the liquid crystal polymer resin at a constant temperature of a melting point of the liquid crystal polymer resin for one minute.

2. The liquid crystal polymer resin as claimed in claim 1, wherein the thermal weight loss of the liquid crystal polymer resin is greater than or equal to 0.040% and less than or equal to 0.100%.

3. The liquid crystal polymer resin as claimed in claim 1, wherein the thermal weight loss of the liquid crystal polymer resin is greater than or equal to 0.050% and less than or equal to 0.088%.

4. The liquid crystal polymer resin as claimed in claim 1, wherein a thermal degradation temperature (Td₉₉) at 1% thermal weight loss of the liquid crystal polymer resin is greater than or equal to 270° C.

5. The liquid crystal polymer resin as claimed in claim 1, wherein a thermal degradation temperature at 1% thermal weight loss of the liquid crystal polymer resin is 280° ° C. to 400° ° C.

6. The liquid crystal polymer resin as claimed in claim 1, wherein the thermal degradation temperature at 1% thermal weight loss of the liquid crystal polymer resin is 290° ° C. to 390° C.

7. The liquid crystal polymer resin as claimed in claim 1, wherein a melting point of the liquid crystal polymer resin is 230° ° C. to 360° C.

8. The liquid crystal polymer resin as claimed in claim 1, wherein the liquid crystal polymer resin further comprises a structure unit represented by the following Formula (II):

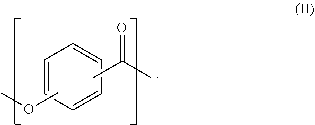

9. The liquid crystal polymer resin as claimed in claim 1, wherein the liquid crystal polymer resin is a wholly aromatic polyester.

10. The liquid crystal polymer resin as claimed in claim 1, wherein the liquid crystal polymer resin is an unrecycled liquid crystal polymer resin, a recycled liquid crystal polymer resin, or a combination thereof.

11. The liquid crystal polymer resin as claimed in claim 2, wherein the liquid crystal polymer resin is an unrecycled liquid crystal polymer resin, a recycled liquid crystal polymer resin, or a combination thereof.

12. The liquid crystal polymer resin as claimed in claim 3, wherein the liquid crystal polymer resin is an unrecycled liquid crystal polymer resin, a recycled liquid crystal polymer resin, or a combination thereof.

13. The liquid crystal polymer resin as claimed in claim 4, wherein the liquid crystal polymer resin is an unrecycled liquid crystal polymer resin, a recycled liquid crystal polymer resin, or a combination thereof.

14. The liquid crystal polymer resin as claimed in claim 5, wherein the liquid crystal polymer resin is an unrecycled liquid crystal polymer resin, a recycled liquid crystal polymer resin, or a combination thereof.

15. The liquid crystal polymer resin as claimed in claim 6, wherein the liquid crystal polymer resin is an unrecycled liquid crystal polymer resin, a recycled liquid crystal polymer resin, or a combination thereof.

16. The liquid crystal polymer resin as claimed in claim 1, wherein the liquid crystal polymer resin includes a recycled liquid crystal polymer resin.

17. The liquid crystal polymer resin as claimed in claim 1, wherein the liquid crystal polymer resin includes a combination of the unrecycled liquid crystal polymer resin and the recycled liquid crystal polymer resin, and an amount of the recycled liquid crystal polymer resin is less than or equal to 40 wt % based on a total weight of the liquid crystal polymer resin.

18. A formed material, made from the liquid crystal polymer resin as claimed in claim 1, wherein the formed material has a tensile strength of 1300 kgf/cm² or more, a tensile modulus of 5000 MPa or more, and an elongation at break of 8.0% or less.

19. The formed material as claimed in claim 18, wherein the formed material has a tensile strength of 1300 kgf/cm² to 1500 kgf/cm², a tensile modulus of 5000 MPa to 7000 MPa, and an elongation at break of 3.0% to 8.0%.
